(19) United States
(12) Patent Application Publication
(10) Pub. No.: US 2007/0230437 A1
(43) Pub. Date: Oct. 4, 2007

(54) Load Control Method in a Packet Data Network

(76) Inventor: Johannes Schopf, Furstenfeldbruck (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/573,169

(22) PCT Filed: Aug. 17, 2004
(86) PCT No.: PCT/EP04/09206

§ 371 Date: Mar. 26, 2007

(30) Foreign Application Priority Data
Sep. 24, 2003 (DE) 103 44 346.0

(51) Int. Cl. H04L 12/56

(52) U.S. Cl. 370/352; 370/229; 370/389; 370/401

(57) ABSTRACT

A method is provided for controlling the load in a packet data network at an interface between the packet data network and a connection-oriented telecommunications network that is connected to the data network, according to which a traffic volume of data of one type, which is routed through the packet data network, is determined periodically. The measured data is then used to calculate a predicted traffic volume for a following period and a subsequent resource reservation, which corresponds to the predicted traffic volume, is carried out in the packet data network for said following period. A media gateway and a media gateway controller for carrying out the inventive method are provided.

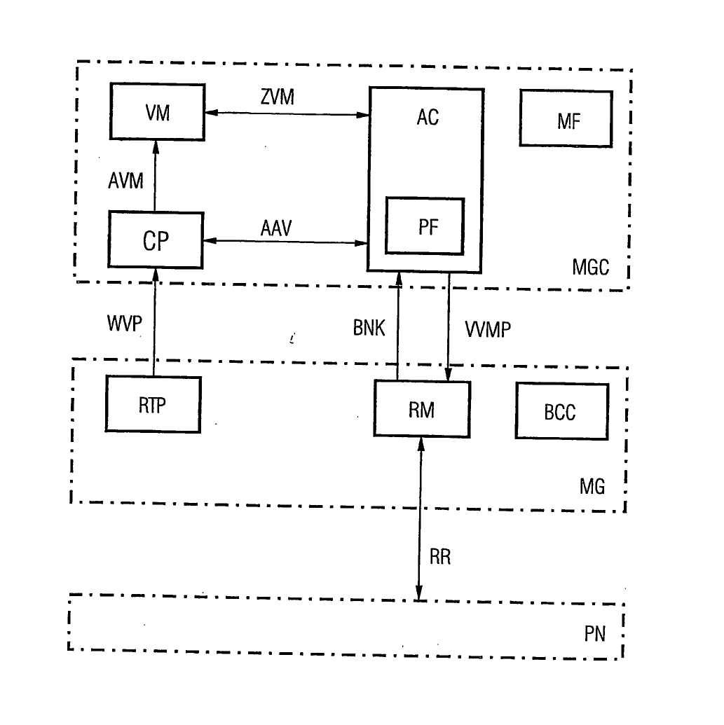

### CROSS REFERENCE TO RELATED APPLICATIONS

This application is the US National Stage of International Application No. PCT/EP2004/009206, filed Aug. 17, 2004 and claims the benefit thereof. The International Application claims the benefits of German application No. 10344346.0 DE filed Sep. 24, 2003, both of the applications are incorporated by reference herein in their entirety.

### FIELD OF INVENTION

The invention relates to a method for controlling the load in a packet data network at an interface between the packet data network and a connection-oriented telecommunications network that is connected to said data network, in accordance with which a traffic volume of data of one type, which is routed through the packet network, is determined periodically. The invention also relates to a Media Gateway and a Media Gateway Controller for carrying out the method in accordance with the invention.

### BACKGROUND OF INVENTION

A packet data network for transferring voice data usually consists of a plurality of interconnected switching nodes as well as a plurality of Media Gateways, abbreviated to MG, which form the interfaces to connection-oriented telecommunications networks and thereby virtually the end points of the packet data network. Examples of connection-oriented telecommunications networks are networks in accordance with the standard for the “Integrated Services digital Network”, abbreviated to ISDN or in accordance with the standard for the “Public Switched Telephone Network”, abbreviated to PSTN. It is of no significance here whether private networks or public networks are involved.

The Media Gateways now have the task of converting the voice streams into a format that can be used in the specific network. In order to implement this, different coding methods are used, for instance, methods in accordance with the standard G.711 or G.723. In this case, the Media Gateways are supported by the Media Gateway Controller, abbreviated to MGC, which has the task of controlling the conversion of the voice streams by the Media Gateways. In such cases this so-called Bearer Control is undertaken based on different signaling interfaces, for example, ISUP, SIP or H.323.

In order to control the bearer, the MGCP protocol (RFC 2705) or the Megaco protocol (H 248) is used for example. It is the task of the packet data network to transfer the packet-based voice streams between the different Media Gateways for each call in accordance with the requirements for a voice service, for example, in respect of the bandwidth, delays, jitter, packet losses, etc. For the voice streams, the underlying network scenario can be described as a network of Media Gateways intermeshed with virtual trunks, said Media gateways being controlled by the Media Gateway Controller.

For the voice service as opposed to other traffic flows, for instance, when transferring files in the packet data network, considerably higher demands are imposed on the guaranteed provision of a sufficient bandwidth, shorter delays, lower packet jitter and data losses. These requirements are combined under the term “Quality of Service”, abbreviated to QoS.

Especially when several types of data are transferred at the same time in the packet data network and the packet data network cannot be overdimensioned for all the types of data, a suitable prioritizing for all the voice packets and checking the required resources of the packet data network prior to the call establishment would be useful, in particular when, in addition to the voice service, other important services still have to be dealt with, the quality of service of which likewise has to be guaranteed.

To this end it is necessary for the terminals of the network to inform the packet data network by means of a so-called “resource reservation” about which resources are needed in which traffic direction. By using the so-called “admission control”, a check is then carried out to determine whether or not the resources of the packet data network are sufficient to be able to guarantee a voice connection with a specific quality of service. Depending on the result of this check, the call is accepted, rejected or redirected.

### SUMMARY OF INVENTION

The admission control is in each case embodied in accordance with the prior art for a call. Therefore, this results in the problem that the devices of the data network, which take over the resource reservation and/or the admission control are subjected to a very high dynamic load because in the case of voice services a great many data records, but comparatively small data records are generated for this and, if required, transferred.

Therefore, an object of the invention consists of specifying a load control in a packet data network, in accordance with which the devices of the data network which take over the resource reservation and/or the admission control, are subjected to a decreased load.

This is done using a method of the type described above,

in accordance with which the measured data is used to calculate a predicted traffic volume for a next period and

in accordance with which a subsequent reservation of resources, which corresponds to the predicted traffic volume, is undertaken in the packet data network for said next period.

The method in accordance with the invention is for example suitable in this case for voice connections which are connected via packet-switching telecommunications networks. This technology is also known by the term Voice over IP, abbreviated to VoIP. However it is equally suitable for other data streams, for instance, video or music in which case there is a traffic control for multiple traffic flows through a packet data network to the end points of the packet data network. Additional variants emerge from the dependent claims as well as from the embodiment.

An important advantage of the invention lies in the fact that problems in the devices of the packet data network with regard to the performance, which are responsible for the access control, are eliminated. Furthermore, the system architecture as well as processes which are already available remain largely unchanged in the components involved method in accordance with the invention can be implemented in practice in a comparatively simple manner.

It is also advantageous if, in the case of an increase/decrease in the traffic volume during a measuring period, the reservation of resources of the packet data network is expanded/restricted for each traffic direction for the next measuring period.

This provides a reaction to changes with regard to the traffic volume or the data throughput to the extent that on an increase in the data throughput, more resources of the packet data network are occupied and vice versa in order to take into account the specified trend. This is a control algorithm, which is very easy to convert for the method in accordance with the invention.

Another advantageous method is one in which the traffic volume corresponds to the data volume transmitted during a measuring period.

In this variant, the integral of the data throughput is formed over the entire measuring period. The result corresponds to the data volume transferred during the entire measuring period. If this data volume is divided by the measuring period, the average data throughput is obtained.

It is particularly advantageous, if the predicted traffic volume is determined using the following formula:
VMP(t+T)=VM(t)·ÜF+(VM(t)−VM(t−T))·TF
in which case t corresponds to a time, T a measuring period, VM(t) a current traffic volume at the point in time t, VM(t−T) a preceding traffic volume at the point in time t−T, VMP(t+T) a predicted traffic volume for the point in time t+T, ÜF an overbooking factor and TF a trend factor.

In this case, the predicted traffic volume VMP(t+T) corresponds to the aggregated bandwidth or the throughput, which has to be requested from the resource reservation function of the packet data network for the next measuring period T. This is established for each traffic link, therefore a path, which has to be switched by the packet data network and each call direction, therefore, depending on whether or not it relates to incoming or outgoing calls.

With the overbooking factor ÜF, a degree of security against the inaccuracy of the algorithm with regard to the prognosis and unforeseen traffic fluctuations is established. If no overbooking is desired, the factor has to be set at 1, for example, for an overbooking of 20%, the factor has to be set at 1.2.

The trend factor TF indicates how quickly there should be a reaction to changes from the one measuring period to the next measuring period. It can be adapted by using individual strategies, for example, depending on the time of day. If it is set to 0, only the preceding traffic volume VM(t) is used for calculating the predicted traffic volume VMP(t+T).

It is noted at this point that the calculation of the predicted traffic volumes can also be carried out with measured values which were determined at other points in time. In this way, the overbooking portion VM(t)·ÜF can, for example, also be calculated for the point in time t−T or t-2T, so that for the overbooking portion, VM(t−T)·ÜF or VM(t−2T)·ÜF is obtained. Needless to say, the same also applies to the trend portion, in which case the two measuring points can also be farther apart in time here, for example 2T. In this case, (VM(t)−VM(t−2T))·TF is for instance obtained for the trend portion.

A particularly advantageous embodiment of the invention is also given by means of a method in which the extent to which a requested transfer quality could be complied with by the packet data network in a period being considered with a view to determining the predicted traffic volume.

In this embodiment an evaluation is undertaken of whether or not the data network was actually in a position to transfer the predicted traffic volume in the requested quality as expected. If this is not applicable, the predicted traffic volume will be adapted accordingly for the next measuring period.

Another advantage is that when the transfer capacity of the packet data network increases/decreases, predicted traffic volumes are increased/decreased from the one measuring period to the next measuring period.

This is a particularly easy-to-implement variant for a load control in accordance with the invention. If it has for example been established that the data network was not in a position to transfer the predicted traffic volume in the requested quality as expected, the predicted traffic volume will be adapted accordingly for the next measuring period, i.e. decreased.

In addition, a particularly advantageous variant of the invention is given with a method,

in which Media Gateways are provided as an interface between the packet data network and a connection-oriented telecommunications network that is connected to said data network,

in which a Media Gateway Controller is provided for controlling the Media Gateways and

in which the predicted traffic volumes are determined for each traffic direction by the Media Gateway Controller and are distributed to the Media Gateways in order to reserve the resources in the packet data network.

In the case of packet data networks which are based on an architecture in accordance with the standard of the Multi Service Switching Forum, abbreviated to MSF, the access control or the admission control is in each case embodied in accordance with the prior art for a call. Because of the digression from an aggregation of requirements for resources in the packet data network and the use of aggregation functions, which evaluate the traffic measurements of switching devices, the load is removed from the resource reservation and/or the admission control. However, also advantageous in this case is the fact that the switching sequences of a Call Feature Server, a Media Gateway Controller or a Softswitch are not concerned here. In this case, only the predicted traffic volumes for each traffic direction are determined by the Media Gateway Controller and distributed to the Media Gateways in order to reserve the resources in the packet data network.

However, advantageous in this case is the fact that bundle-oriented call statistics or a traffic matrix managed in a Media Gateway Controller or in a Call Feature Server are used in order to determine the data throughput.

In this case, the requirements for resources in the terminals of the packet data network are aggregated, for example, in a Media Gateway Controller, a Call Feature Server or in a Softswitch. In such cases the trunk-oriented or bundle-oriented call statistics managed in any event in these elements should be incorporated in the method in accordance with the invention. This allows an especially simple implementation.

The object of the invention is also achieved by a Media Gateway Controller which includes the means for calculating predicted traffic volumes for each traffic direction as well as the means for distributing these predicted traffic volumes to the Media Gateways.

The advantages mentioned for the method in accordance with the invention of course also apply equally to the Media Gateway Controller.

Finally, the object of the invention is also achieved by a Media Gateway which includes the means for receiving a predicted traffic volume as well as the means for reserving the resources in the packet data network corresponding to a predicted traffic volume.

Of course the advantages mentioned in the case of the method in accordance with the invention also apply equally here to the Media Gateway in accordance with the invention.

The invention will now be explained in greater detail by using an exemplary embodiment shown in the drawing, which relates to load control in an IP packet data network.

Although the invention refers to a very widely variety of technologies with reference to a packet data network PN, the following example takes, in particular, a packet data network PN configured with IP routers as a starting basis. The inventive method can be used in such a network for the widest variety of resource reservation and admission control protocols. A resource reservation protocol, abbreviated to RSVP, in accordance with the standards RFC 2205 and 2208 is taken as the starting basis below. However, proprietary interfaces which serve the same purpose would also be feasible in this case. Ideally, there is even an RSVP-like reservation protocol and an admission control protocol between the control device of the packet data network PN and the packet data network PN. These cases, for example, include the following:

Intserv-based packet data networks (RFC 2210 and 2212)

Diffserv-based packet data networks with centralized or decentralized Resource/Bandwidth Brokers (RFC 2474 and 2475)

MPLS (RFC 3031)-based packet data networks provided that they operate with Resource Reservation or Admission Control at the packet data network end point

Combinations of Intserv and Diffserv packet data networks

### BRIEF DESCRIPTION OF THE DRAWING

The FIGURE is a schematic of an exemplary configuration of a Media Gateway Controller (MGC), a Media Gateway (MG) and a Packet Data Network (PN) in accordance to the present invention.

### DETAILED DESCRIPTION OF INVENTION

The FIGURE includes the following functional blocks:

RTP-measurement RTP: In the example shown, this element is implemented on the Media Gateways MG and measures parameters during the call which are relevant as regards the quality of service, in particular the bandwidth, and transmits the latter to the Media Gateway Controller MGC at the end of the call. The measurement of the bandwidths or the traffic volumes as well as additional QoS-relevant parameters is provided in the Real Time Protocol (RTP-RFC 1889 and following), which is in many cases used for the transport of the voice stream via packet data networks.

However, measurements with regard to the bandwidth can also be replaced with a calculation of the packet flow generated by a PSTN channel in a simple development. This is undertaken for each call with due consideration to the packaging period and the encoding protocols used (for example, G.723).

It is pointed out in this context that to provide a clearer overview in the FIGURE only a single Media Gateway MG is shown, but the method in accordance with the invention naturally also refers to a plurality of Media Gateways MG.

Bearer Control/Call Control BCC: The Bearer Control/Call Control BCC is part of the Media Gateway MG and has the task of passing on the QoS-relevant parameters to the Media Gateway Controller MGC by using the MGCP protocol or the Megaco protocol.

Statistics and traffic matrices VM: These are connected closely to the Call Processing CP of the Media Gateway Controllers MGC and are updated for each call. Statistics with regard to a trunk have mostly been implemented in accordance with the ITU standards. The axes of the traffic matrices VM are formed by all the end points of the packet data network PN controlled by the Media Gateway Controller MGC, said end points corresponding to the Media Gateways MG.

If for the control of the voice streams of a Media Gateway MG, a plurality of addresses is required in the packet data network PN, for example, IP addresses, then groups of addresses accordingly have to be used for the axes in each case. In this case, the elements of a traffic matrix VM consist of 2 elements each, which correspond to traffic measuring counters for both a current measuring period and a preceding measuring period. Likewise, the addresses of a plurality of Media Gateways MG which are connected to an end point of the packet data network PN, can be combined.

In this context traffic volumes have been defined as a suitable averaging of transferred volumes per unit of time, for example, in bits or bytes per second. Therefore, in the physical sense, the traffic volume corresponds to a data throughput regardless of a customary definition.

The traffic measuring counters are managed on the basis of bandwidths or traffic volumes of the bearer (different in both directions in the case of asymmetrical applications), which are measured by the Media Gateways MG and reported to the Media Gateway Controller MGC when the call has ended.

The above-mentioned management of the statistics can advantageously be connected to the realtime statistics normally used in the transit switching centers or it can be expanded. However, this function can also be implemented as individual, new statistics.

Prognosis function PF: The traffic measuring counters are evaluated at the end of a measuring period and a trend for the next period is determined by means of a comparison with the previous period. In such cases a certain overbooking for the next interval can generally be taken into account. This achieves the result of still enabling unexpected peaks in traffic to be processed correctly. In accordance with the trend, the overbooking is either increased or decreased. An example of such a function is given below
VMP(t+T)=VM(t)·ÜF+(VM(t)−VM(t−T))·TF
t Time
T Measuring period
VM(t) Current traffic volume at the point in time t
VM(t−T) Preceding traffic volume at the point in time t−T VMP(t+T) Predicted traffic volume for the point in time t+T
ÜF Overbooking factor
TF Trend factor

In this case, as has already been mentioned, the predicted traffic volume VMP(t+T) corresponds to the aggregated bandwidth or the throughput, which has to be requested by the Resource Reservation function of the packet data network for the next measuring period T. With the overbooking factor ÜF, a certain integrity against the inaccuracy of the algorithm with regard to the prognosis and unforeseen traffic fluctuations is established and with the trend factor TF it is possible to indicate how quickly there should be a reaction to changes from the one measuring period to the next measuring period.

In the case of comparatively high traffic flows, the fact that the period of statistics management in the Media Gateway Controller MGC and the distribution of the new predicted traffic flows VMP(t+T) via the Resource Reservation RR, which is obtained in the measuring period T, are slightly shifted does not play an important role here. It is also conceivable for the prognosis function PF to be part of the admission control AC.

Mapping Function MF: The Mapping Function MF for example maps the virtual objectives of bundles onto the addresses of the end points of the packet data network PN in the same way as they are administered in a Media Gateway Controller MGC, a Call Feature Server or a Softswitch.

Reservation Manager RM: The traffic volume to be reserved in a specific traffic direction is distributed at the start of the new measuring period from the Media Gateway Controller MGC to the Media Gateways MG, for instance, as a new MGCP packet in a notification. The addressee of this traffic volume prognosis is the Reservation Manager RM, which represents a functional unit in the Media Gateway MG.

Independently of the Call Processing CP of the Media Gateway MG, the Reservation Manager RM has the task of operating the corresponding Reservation/Admission Control interface of the packet data network PN.

In the case of a RSVP interface, refreshes are carried out autonomously for example on the basis of the traffic volume prognosis until a new traffic prognosis arrives from the Media Gateway Controller MGC. In the case of the RSVP, the protocol elements are lined up in the media data flow of the Media Gateway MG. However, it is also conceivable to send the RSVP messages and a so-called RSVP proxy to a so-called “Edge Router” or a Resource/Bandwidth Controller of the packet data network.

For additional QoS parameters in addition to the bandwidth/traffic volume, such as for example delay, jitter, etc., suitable, strictly administered values can be set for the voice service.

Admission Control AC: This function is required so that the Call Processing CP can either reject or redirect calls in situations in accordance with which the packet data network PN can no longer guarantee the voice quality.

Call Processing CP: This function is responsible for the control of a call.

The function of the arrangement shown in the Figure is as follows:

Distribution of the predicted traffic volumes VVMP: The Admission Control AC informs the Reservation Manager RM at the start of a measuring period about the traffic volume or the throughput for each traffic direction to be expected, which is determined by using the prognosis function PF, by means of a message. The most important parameters included in this message are contained in a list. They are as follows:

IP target addresses

Traffic volumes in the transmit direction

Traffic volumes in the receive direction

Reservation of Resources RR: The exact establishment of these parameters depends on the packet data network PN used and its administration mechanisms for the resources. The interface usually consists of requirement messages of the Reservation Manager RM in the packet data network PN and answers/acknowledgements of the packet data network PN. An example of the parameters of a requirements are as follows:

A list of IP target addresses and in the case of an asymmetrical load the traffic volumes in the transmit direction and in the receive direction

QoS parameters, which for instance have to be adhered to for a voice service. These are as follows: maximum delays, maximum jitters, loss rates of IP packets as well as the rate of the parameters, which are not transferred sequentially

The answer/acknowledgement provides a

go/no-go statement and optionally

the resources actually to be supplied by the packet data network PN

Information about network capacity BNK: The interface between the Reservation Manager RM and the Admission Control AC is used when the packet data network PN cannot fulfill the requirements, which are made on the basis of the predicted traffic volumes VMP(t+T) and instead of fulfilling the demand, sends a message to the Admission Control AC, which could cope with traffic volumes. This message should consist of a list, which at least includes the following parameters:

Target IP address

Source IP address

Traffic volume which can be transferred with the quality in the transmit direction established by the QoS parameters and in the case of an asymmetrical load in the receive direction. The desired, ideal (maximum) QoS parameters are in this case administered advantageously as fixed parameters.

However, the Admission Control AC can also establish the difference between the predicted traffic volume VMP(t+T) and the traffic volume which can be fulfilled by access to the traffic matrix ZVM and, if required, update the prognosis.

Forwarding of the connection parameters WVP: At the end of a connection, the following parameters, which are in each case specified for a connection, are forwarded from the RTP-measurement RTP to the Call Processing CP:

IP target address, this means the address of the called side

IP address of the Media Gateway MG, which was used on calling, this means the address of the calling side

Traffic volume in the transmit direction and in the case of an asymmetrical load of the traffic volume in the receive direction

Actually measured QoS parameters, for example by using the RTCP protocol

For statistical purposes, the QOS parameters can be stored in the Media Gateway Controller MGC. The traffic volume or the throughput can then be determined by dividing the volumes and the durations of the call.

Updating the traffic matrix AVM: At the end of a connection, the statistics data and thereby the traffic matrix VM are updated by the Call Processing CP. To this end the following parameters obtained from the RTP-measurement are required:

IP address of the called side

IP address of the calling side

Traffic volume in the transmit direction and in the case of an asymmetrical load of the traffic volume in the receive direction

Requirement for the establishment of a connection AAV: In this case, the Call Processing CP requests from the Admission Control AC whether or not additional calls can be established. This is done within the framework of the switching sequences at a point in time when the Call Processing CP has obtained the IP address from the source and the target Media Gateways MG by means of signaling protocols. The parameters are as follows:

Target IP address

Source IP address and optionally

a traffic volume to be expected in the transmit direction and in the case of an asymmetrical load of the traffic volume in the receive direction

The answer consists of the following

A message stating whether or not the call is possible

The traffic volume to be expected should be calculated by the Call Processing CP on the basis of the codecs used. If an agreement is reached that only one codec type is used, the parameter can also be administered in a simple manner and must not be calculated for each call.

Access to the traffic matrix ZVM: This interface between the Admission Control AC and the traffic matrix VM is used to read and to update values from the traffic matrix VM. In this case, write and read access to each element of the traffic matrix VM must be possible.

With the above-mentioned components, it is now possible to establish a closed-loop control circuit by means of which the traffic requirements, which occur in a connection-oriented telecommunications network, for instance, a PSTN network, are coordinated with the resource administration of the packet data network PN.

This for instance results in a method in accordance with which, in the case of an increase/decrease in the traffic volume during a measuring period, the reservation of resources of the packet data network PN is expanded/restricted for each traffic direction for the next measuring period by means of an overbooking mechanism.

In addition, when the transmission capacity of the packet data network PN is increased/decreased, the traffic feed can be increased/decreased from the one measuring period to the next measuring period by means of the overbooking mechanism.

The invention can also be used without expansions for the case in which a plurality of Media Gateway Controllers MGC or Softswitches controls a plurality of Media Gateways MG of the packet data network PN.

If the Admission Control AC is undertaken locally, such as for instance in the case of an Intserv approach, an aggregation can, as a result, no longer be carried out in the packet data network PN via a plurality of Media Gateways MG. Therefore, for each Media Gateway MG, an aggregation of the requirements for the resources must be implemented. In this case, topological information is not included in the packet data network PN, by means of which an additional aggregation can be carried out in each case.

If the Admission Control AC is centralized or partly centralized, such as for instance in the case of a Diffserv approach with a bandwidth broker, then a network-wide traffic matrix VM will usually be required, in which an overview of all the Media Gateways MG of the Media Gateway Controller MGC is administered. In addition, in this case an aggregation by the MGC is meaningful.

The method in accordance with the invention can also be used in cases when other interfaces are used instead of the RSVP protocol CORBA. Because said interfaces are possibly not available on a Media Gateway MG, technical variants are conceivable in which CORBA interfaces are implemented on a separate server.

Likewise, the Reservation Manager RM or the traffic matrix VM can for example be implemented with the special statistics function on separate servers.

1.-9. (canceled)

10. A method for controlling a load in a packet data network at an interface between the packet data network and a connection oriented network, comprising:
measuring a traffic volume of a type of data that is routed through the packet network;
calculating a predicted traffic volume for a next time period based on the measured volume; and
reserving packet data network resources corresponding to the predicted traffic volume for the next time period the reserved resources,
wherein the predicted traffic volume is calculated via the formula:
VMP(t+T)=VM(t)·ÜF+(VM(t)−VM(t−T))·TF
wherein
t corresponds to a time,
T is a measuring time period,
VM(t) is a current traffic volume at the point in time t,
VM(t−T) is a preceding traffic volume at the point in time t−T,
VMP(t+T) is a predicted traffic volume for the point in time t+T,
ÜF is an overbooking factor, and
TF is a trend factor.

11. The method according to claim 10,
wherein the resource reservation is expanded for each traffic direction for the next measuring time period when an increase in the traffic volume during the measuring time period, and
wherein a resource reservation is restricted for each traffic direction for the next measuring period when a decrease in the traffic volume during the measuring time period.

12. The method according to claim 11, wherein the traffic volume is a data volume transmitted during the measuring time period.

13. The method according to claim 10, wherein the traffic volume is a data volume transmitted during the measuring time period.

14. The method according to claim 10, wherein a fulfillment of a requested transmission quality by the packet data network in a time period is used when calculating the predicted traffic volume.

15. The method according to claim 11, wherein a fulfillment of a requested transmission quality by the packet data network in a period is used when calculating the predicted traffic volume.

16. The method according to claim 14,
wherein the predicted traffic volume from the measuring time period to a next measuring time period is increased when a transmission capacity of the packet data network is increased, and
wherein the predicted traffic volume from the one measuring period to the next measuring time period is decreased when the transmission capacity of the packet data network is decreased.

17. The method according to claim 10, further comprising:
providing a Media Gateways as an interface between the packet data network and the connection-oriented telecommunications network;
providing a Media Gateway Controller for controlling the Media Gateway;
calculating the predicted traffic volume for each traffic direction by the Media Gateway Controller; and
distributing the calculated volumes to the Media Gateway to reserve a resource in the packet data network.

18. The method according to claim 17, wherein a trunk-group-oriented call statistics or a traffic matrix VM managed in a Media Gateway Controller or in a Call Feature Server are included in determining the data throughput.

19. A Media Gateway Controller for controlling a Media Gateway that interfaces between a packet data network and a connection-oriented telecommunications network, the Media Gateway Controller comprising:
a traffic volume of a type of data is measured;
a measuring time period;
a current traffic volume at a point in time;
a preceding traffic volume at the point in time;
a predicted traffic volume for the point in time;
an overbooking factor;
a trend factor; and
a predicted traffic volume is calculated for a next time period detecting based on the measured volume,
wherein the predicted traffic volume is calculated for each traffic direction by the Media Gateway Controller via the formula VMP(t+T)=VM(t)·ÜF+(VM(t)−VM(t−T))·TF,
wherein
t is the point in time,
T the measuring time period,
VM(t) is the current traffic volume at the point in time t,
VM(t−T) is the preceding traffic volume at the point in time t−T,
VMP(t+T) is the predicted traffic volume for the point in time t+T,
ÜF is the overbooking factor, and
TF is the trend factor, and
wherein the calculated volumes are distributed to the Media Gateway to reserve a resource in the packet data network.

20. A Media Gateway controlled by a Media Gateway Controller, comprising:
a predicted traffic volume sent from a Media Gateway Controller; and
a resource reservationist that reserves a resource in a packet data network based on the predicted traffic volume.
